(19) United States
(12) Patent Application Publication
(10) Pub. No.: US 2021/0173962 A1
(43) Pub. Date: Jun. 10, 2021

(54) METHODS AND SYSTEMS TO COLLECT, AGGREGATE AND VERIFY COLLECTED PERSONAL DATA

(71) Applicant: 11422049 Canada Inc., Mississauga (CA)

(72) Inventor: Sudipta Rajagopal Sarkar, Mississauga (CA)

(21) Appl. No.: 17/112,196

(22) Filed: Dec. 4, 2020

Related U.S. Application Data
(60) Provisional application No. 62/945,977, filed on Dec. 10, 2019.

(51) Int. Cl. G06F 21/64; G06F 16/2455; G06F 21/62; G06F 16/28

(52) U.S. Cl. CPC G06F 21/64; G06F 16/285; G06F 21/6245; G06F 16/24556

(57) ABSTRACT

The present invention provides methods and systems to aggregate and verify collected personal data. In particular, the systems and methods of the present invention provide a single point for the collection of personal information from multiple digital sources. The methods of the present invention comprise collecting data from one or more digital sources; aggregating the data collected from said one or more digital sources; optionally augmenting the aggregated data; and optionally verifying the augmented data.

### FIELD OF THE INVENTION

The present invention generally relates to the field of collecting data and more particularly to collecting and verifying personal data from social media profiles.

### BACKGROUND

Personal information means information about an identifiable individual. What constitutes personal information varies between jurisdictions and is often dictated by local laws such as General Data Protection Regulation (GDPR) in the European Union or Personal Information Protection and Electronic Documents Act (PIPEDA) in Canada. For example, in Canada PIPEDA defines personal information as including any factual or subjective information, recorded or not, about an identifiable individual. This includes information in any form, such as: age, name, ID numbers, income, ethnic origin, or blood type; opinions, evaluations, comments, social status, or disciplinary actions; and employee files, credit records, loan records, medical records, existence of a dispute between a consumer and a merchant, intentions (for example, to acquire goods or services, or change jobs). The EU Data Protection Directive 95/46/EC (DPD) defines personal data as the following: ‘Personal data’ shall mean any information relating to an identified or identifiable natural person (‘data subject’); an identifiable person is one who can be identified, directly or indirectly, in particular by reference to an identification number or to one or more factors specific to his physical, physiological, mental, economic, cultural, or social identity.

During many aspects of daily life, personal information is collected and digitally stored. In order to comply with various privacy laws, companies must be able to provide a copy of the data collected on an individual to that individual. There is not a unified way that the individuals can view and use the information in a manner they can benefit. This is due to the fact the information does not come with a common id, is not verifiable and is of non-uniform structure across different digital footprints.

### SUMMARY OF THE INVENTION

An object of the present invention is to provide methods and systems to aggregate and verify collected personal data. In accordance with an aspect of the present invention, there is provided a method comprising: a. collecting data from one or more digital sources; b. aggregating the data collected from said one or more digital sources; c. optionally augmenting the aggregated data; and d. optionally verifying the augmented data.

### BRIEF DESCRIPTION OF THE FIGURES

These and other features of the invention will become more apparent in the following detailed description in which reference is made to the appended drawings.

FIG. 1 provides a flow chart illustrating an embodiment of the present invention.

FIG. 2 provides an example of data collected from LinkedIn.

FIG. 3 provides an example of data collected from Facebook.

FIG. 4 illustrates an example computing device according to an embodiment of the present disclosure.

### DETAILED DESCRIPTION

The present invention provides methods and systems to compile and, optionally verify data, including personal data. In certain embodiments, the present invention provides a system and method for users to collect and unify their personal information collected from one or more different sources of personal information in a unified and usable format.

In certain embodiments, the methods of the present invention, comprise the following steps:

a. Collecting Personal Information from One or More Digital Sources

The system and method of the present invention provides a single point for the collection of personal information from multiple digital sources. Given that it is typical that a user's information can be found on multiple digital sources, use of a single point collection process may decrease the time and effort required by a user to collect all their personal information from the digital sources.

As used herein, personal information means information about an identifiable individual. What constitutes personal information may be dictated by various legislations such as GDPR or PIPEDA and/or jurisprudence.

As used herein, sources of personal information refer to digital stores of personal information from any organizations, services and sites that collect personal information. Such organizations, services and websites may include but are not limited to social media service providers, social networking service providers, search engine providers, financial service providers, e-commerce providers and payment website providers. Exemplary organizations include but are not limited to LinkedIn™, Facebook™, Google™, Amazon™, eBay™ and PayPal™. In certain embodiments, the sources of digital information are social media profiles.

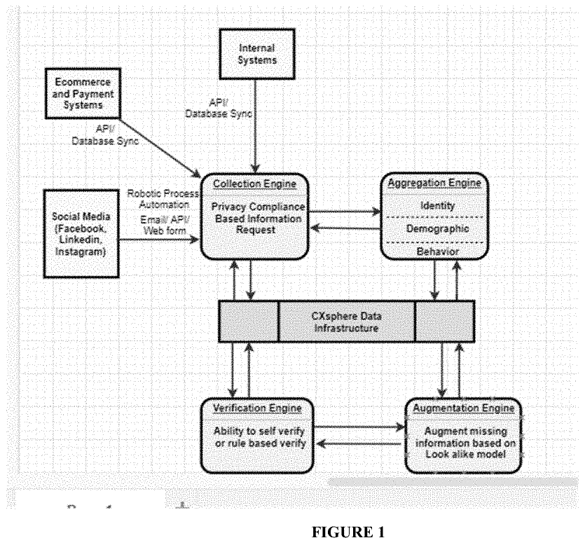

As shown in FIG. 1, collection may be automatic based on consent and predetermined criteria and/or in response to user input. In certain embodiments, the system automatically initiates collection, such as through a collection engine, on a regularly scheduled basis from one or more predetermined service providers/websites or automatically as a result of a predetermined stimulus. The user will need to provide the consent to the CXsphere Data Infrastructure for collecting the information on his/her behalf. For example, if a payment website or other ecommerce or payment system is utilized by an individual, the system may automatically initiate collection of the individual's data collected by the payment website. In certain embodiments, the system initiates collection of data in response to a user's request. The request may simply include a request for data from one or more selected service providers/websites, such as social media providers (i.e., Facebook, LinkedIn, Instagram), or internal systems. In certain embodiments, the system requires confirmation of the identity of the individual requesting the data.

The type of information collected may be based on predetermined criteria and/or in response to user input. In certain embodiments, all personal information about the individual is collected from the one or more sources. In certain embodiments, the personal information collected is from one or more social media profiles.

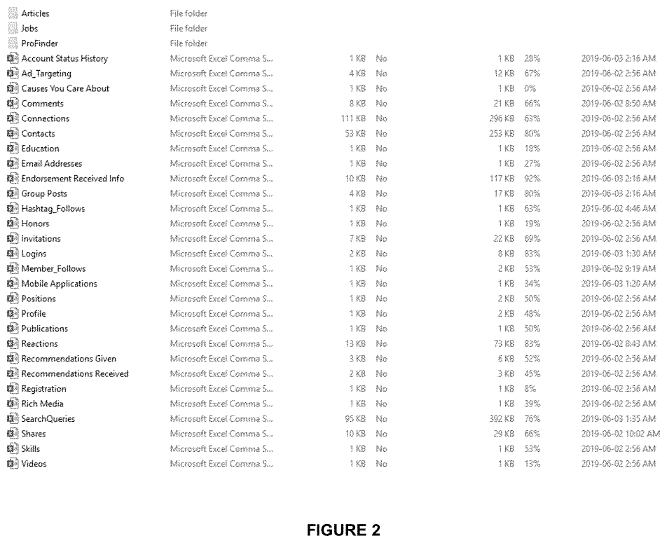

An example of the types of information that may be collected from LinkedIn is shown in FIG. 2.

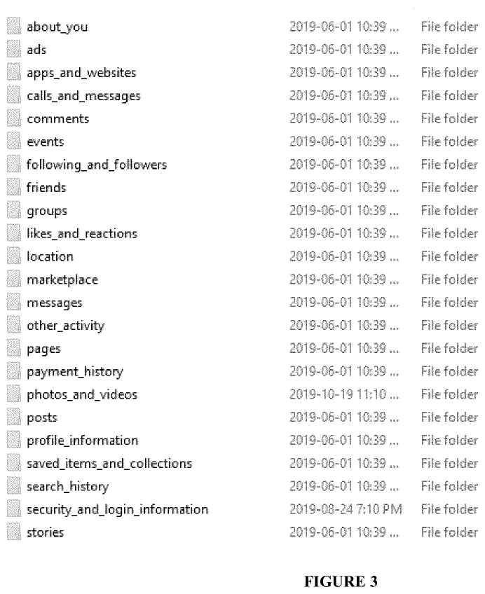

An example of the types of information that may be collected from Facebook is shown in FIG. 3.

How the information is collected will be dependent on the source of the information. In particular, the request may be to a particular email address, through a user interface such as a webpage or using an API. For example, LinkedIn provides an email address where you can request back your individual information; Facebook uses a webpage where you can request back your individual information; Google provides an API to pull back your own information. In certain embodiments, the sources include internal systems which can provide API or direct database connection for the profile information.

In certain embodiments, based on choosing the relevant information source, the system guides the individual to the specific page(s) on social media to collect the information and the individual submits the request for information. In other embodiments, the system automatically requests the information on behalf of the individual.

In certain embodiments, the system/method of the present invention utilizes an authentication protocol which allows third-party applications to sign into the user's accounts. Exemplary authentication protocols include OAuth 2.

b. Aggregating the Information Collected from Said One or More Digital Sources.

The information collected from the one or more digital sources is aggregated by an aggregation engine using one or more common identifiers. The common identifiers may include but are not limited to email address, phone number, IP address, advertisement id (for mobile) and browser fingerprint identifier.

In certain embodiments, the common identifier is an email address and/or a phone number.

In certain embodiments, the aggregated information is structured into one or more groups with one or more grouping variables. The grouping variables may include but are not limited to identity, demographic and behavior information. In certain embodiments, the method of the present invention allows for varying levels of granularity with respect to the groups.

The groups of data may be stored together or separately. One or more of the groups of data may be encrypted. In certain embodiments, the behavior and demographic information is stored in an encrypted fashion with the identity information kept separately and connected only by an encrypted identifier. By storing identity information separate from behavior and demographic information, security is increased. In particular, the information is not as easily correlated in case of a security breach. In certain embodiments, the identity information is stored in a blockchain for further security and data privacy.

c. Optionally Augmenting the Data.

Optionally, augmenting/enriching of the data may be performed by an augmentation engine. In certain embodiments, modelling is used to augment the data. Types of modelling include but is not limited to look alike modelling. In specific embodiments, if information is missing from user profiles, the system predicts the information based on look alike modelling of similar profiles and customer's behavior information.

d Optionally Verifying the Information.

Optionally, the data is verified by a verification engine. In certain embodiments, the system allows the user to verify the data. In certain embodiments, the data is verified automatically based on a set of rules. In certain embodiments, 3^{rd} party verification sources are used to verify the data.

In certain embodiments, if the data is incorrect and the user detects it, then they can correct the data manually.

In certain embodiments, the method/system prompts for correction based on the most recent data across different sources.

In certain embodiments that do not require augmentation, the data can be verified automatically.

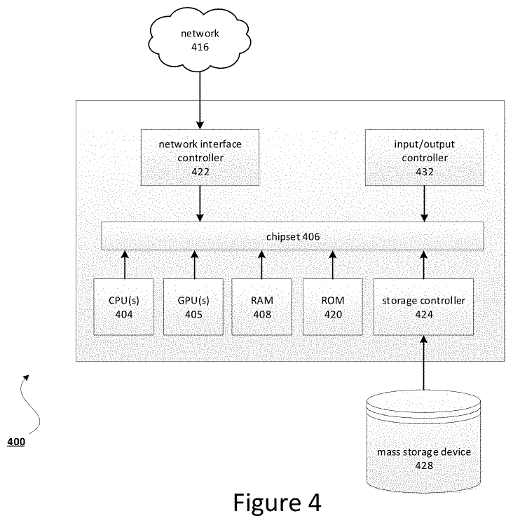

FIG. 4 depicts a computing device that may be used in various aspects. With regard to the example system of FIG. 1, one or more of the engines, the CXsphere data infrastructure, the internal systems and the other systems and websites may be implemented in an instance of a computing device 400 of FIG. 4. The computer architecture shown in FIG. 4 shows a conventional server computer, workstation, desktop computer, laptop, tablet, network appliance, PDA, e-reader, digital cellular phone, or other computing node, and may be utilized to execute any aspects of the computers described herein.

The computing device 400 may include a baseboard, or “motherboard,” which is a printed circuit board to which a multitude of components or devices may be connected by way of a system bus or other electrical communication paths. One or more central processing units (CPUs) 404 may operate in conjunction with a chipset 406. The CPU(s) 404 may be standard programmable processors that perform arithmetic and logical operations necessary for the operation of the computing device 400.

The CPU(s) 404 may perform the necessary operations by transitioning from one discrete physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, and the like.

The CPU(s) 404 may be augmented with or replaced by other processing units, such as GPU(s) 405. The GPU(s) 405 may comprise processing units specialized for but not necessarily limited to highly parallel computations, such as graphics and other visualization-related processing.

A user interface may be provided between the CPU(s) 404 and the remainder of the components and devices on the baseboard. The interface may be used to access a random access memory (RAM) 408 used as the main memory in the computing device 400. The interface may be used to access a computer-readable storage medium, such as a read-only memory (ROM) 420 or non-volatile RAM (NVRAM) (not shown), for storing basic routines that may help to start up the computing device 400 and to transfer information between the various components and devices. ROM 420 or NVRAM may also store other software components necessary for the operation of the computing device 400 in accordance with the aspects described herein. The user interface may be provided by a one or more electrical components such as the chipset 406.

The computing device 400 may operate in a networked environment using logical connections to remote computing nodes and computer systems through local area network (LAN) 416. The chipset 406 may include functionality for providing network connectivity through a network interface controller (NIC) 422, such as a gigabit Ethernet adapter. A NIC 422 may be capable of connecting the computing device 400 to other computing nodes over a network 416. It should be appreciated that multiple NICs 422 may be present in the computing device 400, connecting the computing device to other types of networks and remote computer systems.

The computing device 400 may be connected to a storage device 428 that provides non-volatile storage for the computer. The storage device 428 may store system programs, application programs, other program modules, and data, which have been described in greater detail herein. The storage device 428 may be connected to the computing device 400 through a storage controller 424 connected to the chipset 406. The storage device 428 may consist of one or more physical storage units. A storage controller 424 may interface with the physical storage units through a serial attached SCSI (SAS) interface, a serial advanced technology attachment (SATA) interface, a fiber channel (FC) interface, or other type of interface for physically connecting and transferring data between computers and physical storage units.

The computing device 400 may store data on a storage device 428 by transforming the physical state of the physical storage units to reflect the information being stored. The specific transformation of a physical state may depend on various factors and on different implementations of this description. Examples of such factors may include, but are not limited to, the technology used to implement the physical storage units and whether the storage device 428 is characterized as primary or secondary storage and the like.

For example, the computing device 400 may store information to the storage device 428 by issuing instructions through a storage controller 424 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 400 may read information from the storage device 428 by detecting the physical states or characteristics of one or more particular locations within the physical storage units.

In addition, or alternatively to the storage device 428 described herein, the computing device 400 may have access to other computer-readable storage media to store and retrieve information, such as program modules, data structures, or other data. It should be appreciated by those skilled in the art that computer-readable storage media may be any available media that provides for the storage of non-transitory data and that may be accessed by the computing device 400.

By way of example and not limitation, computer-readable storage media may include volatile and non-volatile, transitory computer-readable storage media and non-transitory computer-readable storage media, and removable and non-removable media implemented in any method or technology. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other medium that may be used to store the desired information in a non-transitory fashion.

A storage device, such as the storage device 428 depicted in FIG. 4, may store an operating system utilized to control the operation of the computing device 400. The operating system may comprise a version of the LINUX operating system. The operating system may comprise a version of the WINDOWS SERVER operating system from the MICROSOFT Corporation. According to additional aspects, the operating system may comprise a version of the UNIX operating system. Various mobile phone operating systems, such as IOS and ANDROID, may also be utilized. It should be appreciated that other operating systems may also be utilized. The storage device 428 may store other system or application programs and data utilized by the computing device 400.

The storage device 428 or other computer-readable storage media may also be encoded with computer-executable instructions, which, when loaded into the computing device 400, transforms the computing device from a general-purpose computing system into a special-purpose computer capable of implementing the aspects described herein. These computer-executable instructions transform the computing device 400 by specifying how the CPU(s) 404 transition between states, as described herein. The computing device 400 may have access to computer-readable storage media storing computer-executable instructions, which, when executed by the computing device 400, may perform any methods described herein.

A computing device, such as the computing device 400 depicted in FIG. 4, may also include an input/output controller 432 for receiving and processing input from a number of input devices, such as a keyboard, a mouse, a touchpad, a touch screen, an electronic stylus, or other type of input device. Similarly, an input/output controller 432 may provide output to a display, such as a computer monitor, a flat-panel display, a digital projector, a printer, a plotter, or other type of output device. It will be appreciated that the computing device 400 may not include all of the components shown in FIG. 4, may include other components that are not explicitly shown in FIG. 4, or may utilize an architecture completely different than that shown in FIG. 4.

As described herein, a computing device may be a physical computing device, such as the computing device 400 of FIG. 4. A computing node may also include a virtual machine host process and one or more virtual machine instances. Computer-executable instructions may be executed by the physical hardware of a computing device indirectly through interpretation and/or execution of instructions stored and executed in the context of a virtual machine.

One skilled in the art will appreciate that the systems and methods disclosed herein may be implemented via a computing device that may comprise, but are not limited to, one or more processors, a system memory, and a system bus that couples various system components including the processor to the system memory. In the case of multiple processors, the system may utilize parallel computing.

For purposes of illustration, application programs and other executable program components such as the operating system are illustrated herein as discrete blocks, although it is recognized that such programs and components reside at various times in different storage components of the computing device, and are executed by the data processor(s) of the computer. An implementation of service software may be stored on or transmitted across some form of computer-readable media. Any of the disclosed methods may be performed by computer-readable instructions embodied on computer-readable media. Computer-readable media may be any available media that may be accessed by a computer. By way of example and not meant to be limiting, computer-readable media may comprise “computer storage media” and “communications media.” “Computer storage media” comprise volatile and non-volatile, removable and non-removable media implemented in any methods or technology for storage of information such as computer-readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by a computer. Application programs and the like and/or storage media may be implemented, at least in part, at a remote system.

As used in the specification and the appended claims, the singular forms “a,” “an” and “the” include plural referents unless the context clearly dictates otherwise. Ranges may be expressed herein as from “about” one particular value, and/or to “about” another particular value. Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect.

It will be apparent to those skilled in the art that various modifications and variations may be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed:

1. A method comprising:
a. collecting data from one or more digital sources;
b. aggregating the data collected from said one or more digital sources;
c. optionally augmenting the aggregated data; and
d. optionally verifying the augmented data.

2. The method of claim 1, wherein said data is personal information.

3. The method of claim 2, wherein said personal information comprises social media profiles.

4. The method of claim 1, wherein said collecting data is automatic.

5. The method of claim 1, wherein said collecting data is in response to user input.

6. The method of claim 1, wherein one or more common identifiers are used for aggregating said data.

7. The method of claim 6, wherein said one or more common identifiers comprise email address and/or phone number.

8. The method of claim 1, wherein the aggregated data is structured into one or more groups with one or more grouping variables.

9. The method of claim 8, wherein the one or more grouping variables comprise identity, demographic and behavior information.

10. The method of claim 1, wherein look alike modelling is utilized to augment the aggregated data.

11. The method of claim 1, wherein said augmented data is verified automatically based on a set of rules.

12. The method of claim 1, wherein said collecting utilizes an authentication protocol to access the one or more digital sources.
